(19) United States
(12) Patent Application Publication
(10) Pub. No.: US 2012/0061532 A1
(43) Pub. Date: Mar. 15, 2012

(54) ISLAND LEG

(76) Inventor: Leon A. Osborne, Toccoa, GA (US)

(21) Appl. No.: 12/883,108

(22) Filed: Sep. 15, 2010

(51) Int. Cl. A47B 13/00; F16M 11/22

(52) U.S. Cl. 248/163.1; 248/188.8

(57) ABSTRACT

A combination wood and metal island leg is disclosed having at least one wood leg element and at least one metal leg element. The wood and metal leg elements are adapted for a vertical coupling to form a combination wood and metal island leg. In one embodiment, a modular leg mount assembly includes a first wood turning, a metal turning, a second wood turning, and a metal foot. The first wood turning, the metal turning, the second wood turning, and the metal foot are adapted for a vertical coupling to form a combination wood and metal leg. In one embodiment, an island table includes a platform and a multiplicity of combination wood and metal island legs mounted to an underside of the platform to provide structural support to the platform and maintain the platform securely at a predetermined height.

### FIELD OF THE INVENTION

The technology described herein relates generally to the fields of furniture, metal turning, and wood turning. More specifically, the technology described herein relates to an improved island leg manufactured of turned elements of at least two varied types, including two or more elements of wood, metal, stone, plastic, acrylic, cement, and cold cast plaster, secured together for the structural support of a table, kitchen island, desk, and other related articles of furniture.

### BACKGROUND OF THE INVENTION

Table legs, island legs, and the like provide structural support to a table, kitchen island, or like article of furniture. Table legs that are removable from a table are known in the background art.

Related patents and published patent applications known in the background art include the following: U.S. Pat. No. 4,662,591, issued to Encontre on May 5, 1987, discloses a table leg mount.

The foregoing patent information reflects the state of the art of which the inventor is aware and is tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

Thus, there remains a need for an improved island leg apparatus manufactured of at least two varied types of leg elements, including two or more of wood, metal, stone, plastic, acrylic, cement, and cold cast plaster elements secured together to support a table, kitchen island, desk, and other related articles of furniture. The technology described herein addresses these unmet needs.

### BRIEF SUMMARY OF THE INVENTION

In various exemplary embodiments, the technology described herein provides an improved island leg manufactured of elements of at least two varied types, including two or more elements of wood, metal, stone, plastic, acrylic, cement, and cold cast plaster elements, secured together for the structural support of a table, kitchen island, desk, and other related articles of furniture.

In one exemplary embodiment, the technology described herein provides a combination island leg. The combination island leg includes at least one first leg element and at least one second leg element. The at least one first leg element and the at least one second leg element are adapted for structural support of an island, table, or the like, and are selected from the group consisting of: wood, metal, stone, plastic, acrylic, cement, and cold cast plaster. The at least one first leg element and the at least second metal leg element are adapted for a vertical coupling to form a combination leg.

The combination island leg also can include a rod adapted to couple the at least one first leg element and the at least one second leg element one to another to form the combination island leg. The at least one first leg element includes a first vertical aperture adapted for receipt of the rod. The at least one second leg element includes a second vertical aperture adapted for receipt of the rod. The rod can be a hex bolt that is threaded through the first vertical aperture of the at least one first leg element and the second vertical aperture of the at least one second leg element, to form the combination island leg.

The at least one first leg element can be a wood turning. The at least one second leg element can be a metal turning. In an at least one embodiment, the at least one first leg element includes a first wood turning and a second wood turning, the at least one second leg element includes a metal turning and a metal foot, the first wood turning, second wood turning, metal turning, and metal foot are stacked and coupled such that the metal foot is disposed on a bottom portion of the combination island leg, the second wood turning is disposed upon the metal foot, the metal turning is disposed upon the second wood turning, and the first wood turning is disposed upon the metal turning, the metal foot is adapted for placement upon a floor surface, and the first wood turning is adapted for mount to an underside of an island table. In this embodiment, a rod can be adapted to couple the first wood turning, the metal turning, the second wood turning, and the metal foot one to another to form the combination wood and metal island leg. The first wood turning includes a first vertical aperture adapted for receipt of the rod. The metal turning includes a second vertical aperture adapted for receipt of the rod. The second wood turning includes a third vertical aperture adapted for receipt of the rod. The metal foot includes a fourth vertical aperture adapted for receipt of the rod. A nut is adapted to couple to the rod and secure the first wood turning, metal turning, second wood turning, and metal foot in place.

The combination island leg further can include a projection disposed upon at least one first end of the at least one first leg element. The projection is adapted for coupling with the at least one second leg element. The combination island leg further can include a recess disposed upon at least one second end of the at least one second leg element. The recess is adapted for receipt of the projection and for coupling with the at least one first leg element.

In another exemplary embodiment, the technology described herein provides a modular leg mount assembly. The modular leg mount assembly includes a first wood turning, a metal turning, a second wood turning, and a metal foot. The first wood turning, the metal turning, the second wood turning, and the metal foot are adapted for a vertical coupling to form a combination wood and metal leg.

The modular leg mount assembly also can include a rod adapted to couple the first wood turning, the metal turning, the second wood turning, and the metal foot one to another to form the combination wood and metal island leg. The first wood turning includes a first vertical aperture adapted for receipt of the rod. The metal turning includes a second vertical aperture adapted for receipt of the rod. The second wood turning includes a third vertical aperture adapted for receipt of the rod. The metal foot includes a fourth vertical aperture adapted for receipt of the rod. The rod can be a hex bolt that is threaded through the first vertical aperture of the first wood turning, the second vertical aperture of the metal turning, the third vertical aperture of the second wood turning, and the fourth vertical aperture of the metal foot, to form the combination wood and metal leg. A nut is adapted to couple to the rod and secure the first wood turning, metal turning, second wood turning, and metal foot in place.

In yet another exemplary embodiment, the technology described herein provides an island table. The island table includes an island table platform and a multiplicity of combination island legs mounted to an underside of the island table platform to provide structural support to the island table platform and maintain the island table platform securely at a predetermined height. The combination island legs include at least one first leg element and at least one second leg element. The at least one first leg element and the at least one second leg element are adapted for a vertical coupling to form each of the combination island legs. The at least one first leg element and the at least one second leg element are adapted for structural support of an island, table, or the like, and are selected from the group consisting of: wood, metal, stone, plastic, acrylic, cement, and cold cast plaster.

The legs of the island table also can include a rod adapted to couple the at least one first leg element and the at least one second leg element one to another to form the combination island leg. The at least one first leg element includes a first vertical aperture adapted for receipt of the rod. The at least one second leg element includes a second vertical aperture adapted for receipt of the rod.

The legs of the island table also can include at least one first leg element having a wood turning and at least one second leg element having a metal turning. In one embodiment, the island table includes the at least one first leg element having a first wood turning and a second wood turning and the at least one second leg element having a metal turning and a metal foot. The first wood turning, second wood turning, metal turning, and metal foot are stacked and coupled such that the metal foot is disposed on a bottom portion of the combination island leg, the second wood turning is disposed upon the metal foot, the metal turning is disposed upon the second wood turning, and the first wood turning is disposed upon the metal turning. The metal foot is adapted for placement upon a floor surface. The first wood turning is adapted for mount to an underside of an island table. A rod is adapted to couple the first wood turning, the metal turning, the second wood turning, and the metal foot one to another to form the combination wood and metal island leg. A nut is adapted to couple to the rod and secure the first wood turning, metal turning, second wood turning, and metal foot in place. The first wood turning includes a first vertical aperture adapted for receipt of the rod. The metal turning includes a second vertical aperture adapted for receipt of the rod. The second wood turning includes a third vertical aperture adapted for receipt of the rod. The metal foot includes a fourth vertical aperture adapted for receipt of the rod. Each of the elements in the combination island leg can be one of wood, metal, stone, plastic, acrylic, cement, and cold cast plaster.

Each of the plurality of combination island legs used in the island table further can include a projection disposed upon at least one first end of the at least one first leg element. The projection is adapted for coupling with the at least one second leg element. Each of the plurality of combination island legs used in the island table further can include a recess disposed upon at least one second end of the at least one second leg element. The recess is adapted for receipt of the projection and for coupling with the at least one first leg element.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the technology described herein. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a front perspective view of a multiplicity of island legs, illustrating, in particular, the island legs collectively providing structural support to a kitchen island, according to an embodiment of the technology described herein;

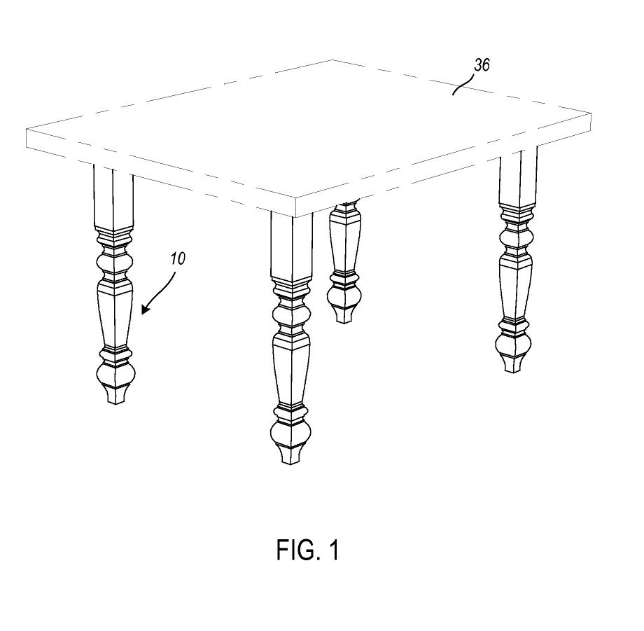

FIG. 2 is a front perspective view of the multiplicity of island legs depicted in FIG. 1, in particular, the central metal elements of the island legs and the resistance to wear, according to an embodiment of the technology described herein;

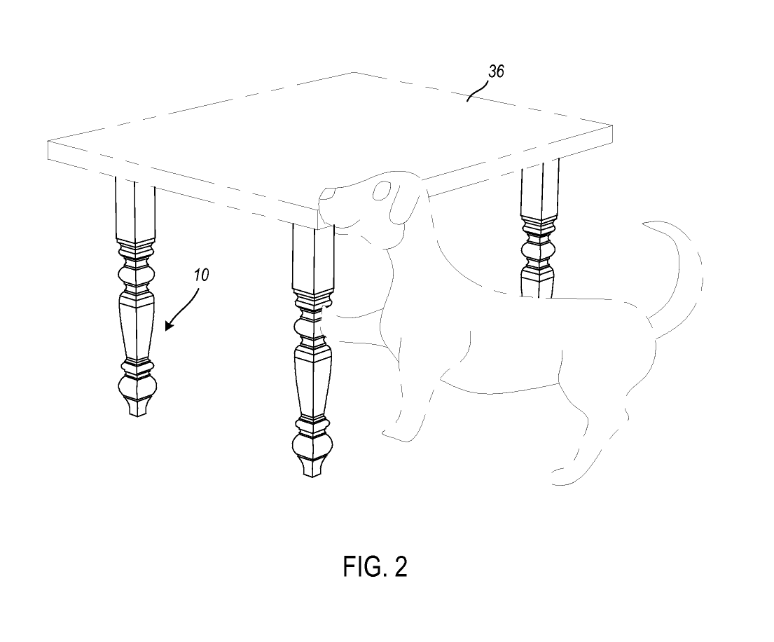

FIG. 3 is a front perspective view of the multiplicity of island legs depicted in FIG. 1, illustrating, in particular, the metal foot elements of the island legs and the resistance to wear, according to an embodiment of the technology described herein;

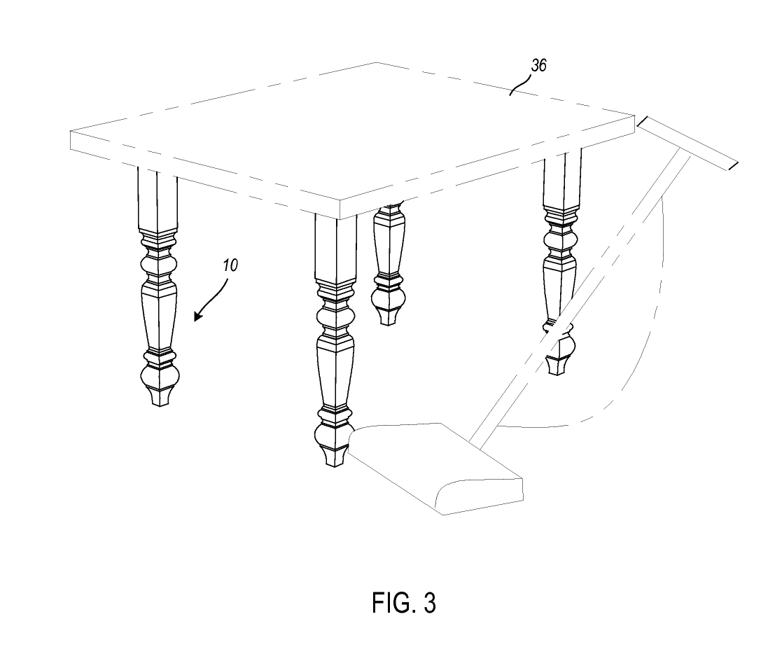

FIG. 4 is a front perspective view of an island leg, illustrating, in particular, both metal and wood elements secured together in a single leg, according to an embodiment of the technology described herein;

FIG. 5 is an expanded front perspective view of the island leg depicted in FIG. 4, illustrating, in particular, the rod holes within the elements and connectivity recesses and ends of the wood and metal elements, according to an embodiment of the technology described herein; and

FIG. 6 is a cross sectional view of the island leg depicted in FIG. 4, illustrating, in particular, the connectivity rod and nut, according to an embodiment of the technology described herein.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides an improved island leg manufactured of elements of at least two varied types, including two or more elements of wood, metal, stone, plastic, acrylic, cement, and cold cast plaster elements, secured together for the structural support of a table, kitchen island, desk, and other related articles of furniture.

Referring now to the Figures, in various exemplary embodiments, the technology described herein provides a combination wood and metal island leg 10. The combination island leg 10 is adapted to provide the structural support of a table top 36, kitchen island, desk, and other related articles of furniture. Furthermore, the combination island leg 10 provides aesthetic alternatives to wood-only and metal-only table legs. As depicted in the Figures, the legs are combination wood and metal. However, alternative materials can be used singly or in combination to form the combination island leg. By way of example, each of the elements in the combination island leg can be one of wood, metal, stone, plastic, acrylic, cement, and cold cast plaster.

The combination island leg 10 includes at least one wood leg element 18, 22 and at least one metal leg element 20, 12. The at least one wood leg element 18, 22 and the at least one metal leg element 20, 12 are adapted for a vertical coupling to form a combination wood and metal island leg 10.

The combination island leg 10 includes a rod 14 adapted to couple the at least one wood leg element 18, 22 and the at least one metal leg element 20, 12 one to another to form the combination wood and metal island leg 10. The rod 14 is metal or other strong suitable material sufficient to securely hold the table leg elements together. The at least one wood leg element 18, 22 includes a vertical aperture 26 adapted for receipt of the rod 14. The at least one metal leg element 20, 12 comprises a vertical aperture 26 adapted for receipt of the rod 14.

In at least one embodiment, the rod 14 includes a hex bolt that is threaded through the vertical aperture 26 of the at least one wood leg element 18, 22 and the vertical aperture 26 of the at least one metal leg element 20, 12, to form the combination wood and metal island leg 10.

In at least one embodiment, the combination island leg 10 includes at least one wood leg element 18, 22 that is a wood turning. In at least one embodiment, the combination island leg 10 includes at least one metal leg element 20, 12 that is a metal turning. By way of example, the wood turnings and the metal turning can be square profile turnings.

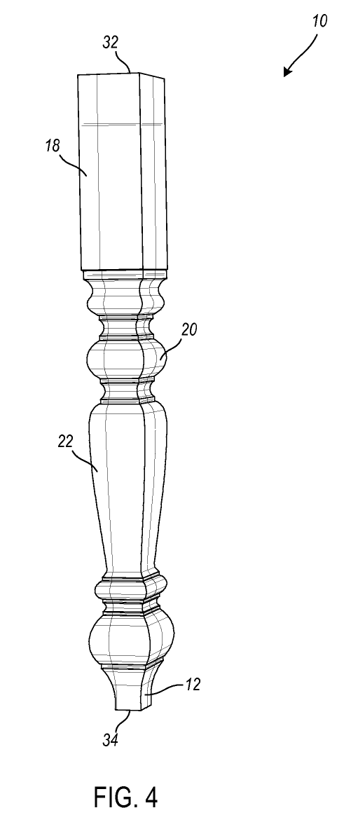

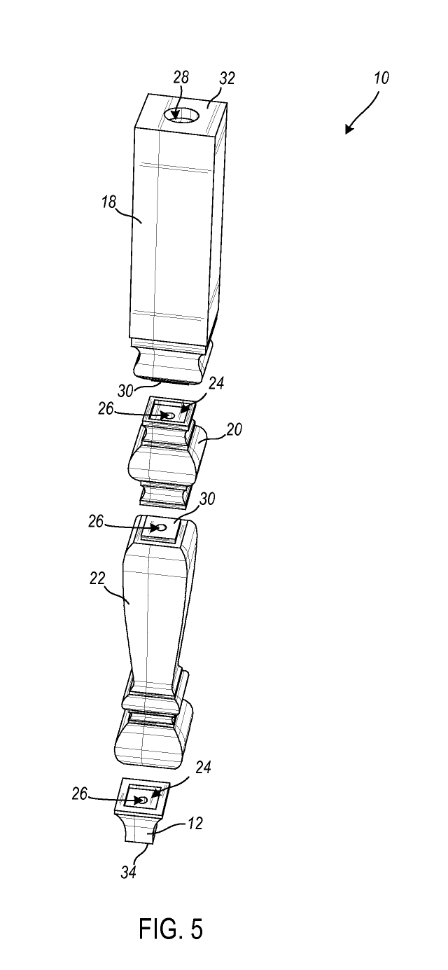

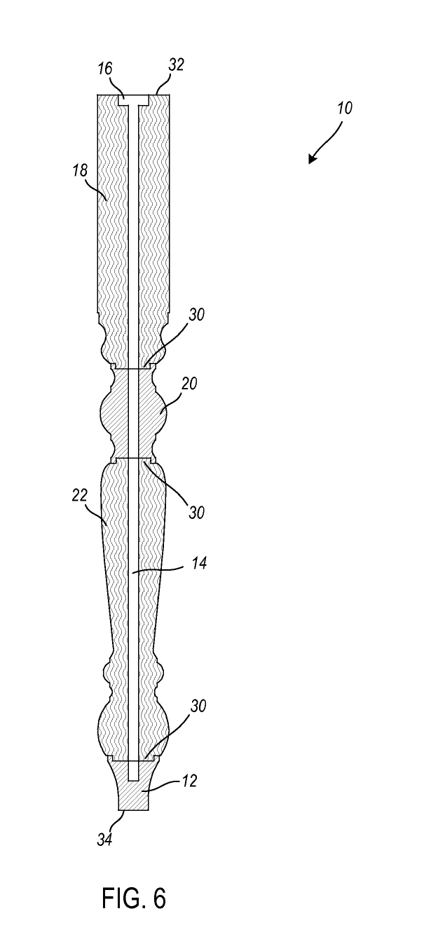

As depicted specifically in FIGS. 4, 5, and 6, the combination island leg 10 includes a first wood turning 18, a second wood turning 22, a metal turning 20, and a metal foot 12. The first wood turning 18 includes top edge 32. The top edge 32 is mounted adjacent and perpendicular to the underside of a table, island, or like article of furniture. The metal foot 12 includes bottom edge 34 that is adapted for placement upon a floor surface.

In at least one embodiment, the first wood turning 18, second wood turning 22, metal turning 20, and metal foot 12 are stacked and coupled such that the metal foot 12 is disposed on a bottom portion of the combination wood and metal island leg 10, the second wood turning 22 is disposed upon the metal foot 12, the metal turning 20 is disposed upon the second wood turning 22, and the first wood turning 18 is disposed upon the metal turning. It will be apparent to one of ordinary skill in the art, upon reading this disclosure, that the order, number, spacing, etc. of metal and wood elements can vary in various applications.

In this embodiment, a rod 14 is adapted to couple the first wood turning 18, the metal turning 20, the second wood turning 22, and the metal foot 12 one to another to form the combination wood and metal island leg 10. The first wood turning includes a vertical aperture 26 adapted for receipt of the rod 14. The metal turning includes a vertical aperture 26 adapted for receipt of the rod 14. The second wood turning includes a vertical aperture 26 adapted for receipt of the rod 14. The metal foot includes a vertical aperture 16 adapted for receipt of the rod 14.

In this embodiment, a nut 16 is adapted to couple to the rod 14 in recess 28, for example, and secure the first wood turning 18, metal turning 20, second wood turning 22, and metal foot 12 in place. The rod 14 can be a cylindrical metal rod utilized with a nut 16. Additionally, the rod 14 can be a threaded hex bolt, or the like, to secure these elements together.

The first wood turning 18, metal turning 20, second wood turning 22, and metal foot 12 can each utilize one or more projection 30 and/or recess 24. By way of example, and as depicted in the Figures, a projection 30 is disposed upon at least one end of the at least one wood leg element 18, 22. The projection 30 is adapted for coupling the at least one wood leg element 18, 22 with the at least one metal leg element 20, 12. A recess 24 exists in at least one end of the at least one metal leg element 20, 12. The recess 24 is adapted for receipt of the projection 30 and for coupling with the at least one wood leg element 18, 22.

By way of example, a combination wood and metal island leg 10 is manufactured by the following steps:
Turn the wooden elements from turning blanks that have a ½″ wide hole through the center (the shorter, top piece will also need to have the hole in the top recessed to accept a nut, which will hold the entire leg together);
Turn the middle metal piece into a square profile with a ½″ hole through the center;
Turn the metal foot into a square profile with a hole tapped to fit threaded rod;
Screw the threaded rod into the foot;
Place the longer wood turning on the rod on top of the foot;
Place the remaining metal turning on top of that, followed by the wooden top square; and
Use a nut to create tension (this will hold the leg together).

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the technology described herein and are intended to be covered by the following claims.

What is claimed is:

1. A combination island leg comprising:
at least one first leg element; and
at least one second leg element;
wherein the at least one first leg element and the at least one second leg element are adapted for structural support of an island, table, or the like, and are selected from the group consisting of: wood, metal, stone, plastic, acrylic, cement, and cold cast plaster; and
wherein the at least one first leg element and the at least one second leg element are adapted for a vertical coupling to form a combination island leg.

2. The combination island leg of claim 1, further comprising:
a rod adapted to couple the at least one first leg element and the at least one second leg element one to another to form the combination island leg;
wherein the at least one first leg element comprises a first vertical aperture adapted for receipt of the rod;
wherein the at least one second leg element comprises a second vertical aperture adapted for receipt of the rod.

3. The combination island leg of claim 2, wherein the rod comprises a hex bolt that is threaded through the first vertical aperture of the at least one first leg element and the second vertical aperture of the at least one second leg element, to form the combination island leg.

4. The combination island leg of claim 1, wherein the at least one first leg element comprises a wood turning.

5. The combination island leg of claim 1, wherein the at least one second leg element comprises a metal turning.

6. The combination island leg of claim 1,
wherein the at least one first leg element comprises a first wood turning and a second wood turning;
wherein the at least one second leg element comprises a metal turning and a metal foot;
wherein the first wood turning, second wood turning, metal turning, and metal foot are stacked and coupled such that the metal foot is disposed on a bottom portion of the combination wood and metal island leg, the second wood turning is disposed upon the metal foot, the metal turning is disposed upon the second wood turning, and the first wood turning is disposed upon the metal turning;
wherein the metal foot is adapted for placement upon a floor surface; and
wherein the first wood turning is adapted for mount to an underside of an island table.

7. The combination island leg of claim 6, further comprising:
a rod adapted to couple the first wood turning, the metal turning, the second wood turning, and the metal foot one to another to form the combination wood and metal island leg;
wherein the first wood turning comprises a first vertical aperture adapted for receipt of the rod;
wherein the metal turning comprises a second vertical aperture adapted for receipt of the rod;
wherein the second wood turning comprises a third vertical aperture adapted for receipt of the rod; and
wherein the metal foot comprises a fourth vertical aperture adapted for receipt of the rod.

8. The combination island leg of claim 7, further comprising:
a nut adapted to couple to the rod and secure the first wood turning, metal turning, second wood turning, and metal foot in place.

9. The combination island leg of claim 1, further comprising:
a projection disposed upon at least one first end of the at least one first leg element, the projection adapted for coupling with the at least one second leg element; and
a recess disposed upon at least one second end of the at least one second leg element and adapted for receipt of the projection and for coupling with the at least one first leg element.

10. A modular leg mount assembly comprising:
a first wood turning;
a metal turning;
a second wood turning; and
a metal foot;
wherein the first wood turning, the metal turning, the second wood turning, and the metal foot are adapted for a vertical coupling to form a combination wood and metal leg.

11. The modular leg mount assembly of claim 10, further comprising:
a rod adapted to couple the first wood turning, the metal turning, the second wood turning, and the metal foot one to another to form the combination wood and metal island leg;
wherein the first wood turning comprises a first vertical aperture adapted for receipt of the rod;
wherein the metal turning comprises a second vertical aperture adapted for receipt of the rod;
wherein the second wood turning comprises a third vertical aperture adapted for receipt of the rod; and
wherein the metal foot comprises a fourth vertical aperture adapted for receipt of the rod.

12. The modular leg mount assembly of claim 11, wherein the rod comprises a hex bolt that is threaded through the first vertical aperture of the first wood turning, the second vertical aperture of the metal turning, the third vertical aperture of the second wood turning, and the fourth vertical aperture of the metal foot, to form the combination wood and metal leg.

13. The modular leg mount assembly of claim 12, further comprising:
a nut adapted to couple to the rod and secure the first wood turning, metal turning, second wood turning, and metal foot in place.

14. An island table comprising:
an island table platform; and
a plurality of combination island legs mounted to an underside of the island table platform to provide structural support to the island table platform and maintain the island table platform securely at a predetermined height.

15. The island table of claim 14, wherein each of the plurality of combination island legs further comprises:
at least one first leg element; and
at least one second leg element;
wherein the at least one first leg element and the at least one second leg element are adapted for structural support of an island, table, or the like, and are selected from the group consisting of: wood, metal, stone, plastic, acrylic, cement, and cold cast plaster; and
wherein the at least one first leg element and the at least one second leg element are adapted for a vertical coupling to form a combination island leg.

16. The island table of claim 15, wherein each of the plurality of combination island legs further comprises:
a rod adapted to couple the at least one first leg element and the at least one second leg element one to another to form the combination island leg;
wherein the at least one first leg element comprises a first vertical aperture adapted for receipt of the rod;
wherein the at least one second leg element comprises a second vertical aperture adapted for receipt of the rod.

17. The island table of claim 15,
wherein the at least one first leg element comprises a wood turning; and
wherein the at least one second leg element comprises a metal turning.

18. The island table of claim 15,
wherein the at least one first leg element comprises a first wood turning and a second wood turning;
wherein the at least one second leg element comprises a metal turning and a metal foot;
wherein the first wood turning, second wood turning, metal turning, and metal foot are stacked and coupled such that the metal foot is disposed on a bottom portion of the combination wood and metal island leg, the second wood turning is disposed upon the metal foot, the metal turning is disposed upon the second wood turning, and the first wood turning is disposed upon the metal turning;
wherein the metal foot is adapted for placement upon a floor surface; and
wherein the first wood turning is adapted for mount to an underside of an island table.

19. The island table of claim 18, further comprising:
a rod adapted to couple the first wood turning, the metal turning, the second wood turning, and the metal foot one to another to form the combination wood and metal island leg; and
a nut adapted to couple to the rod and secure the first wood turning, metal turning, second wood turning, and metal foot in place;
wherein the first wood turning comprises a first vertical aperture adapted for receipt of the rod;
wherein the metal turning comprises a second vertical aperture adapted for receipt of the rod;
wherein the second wood turning comprises a third vertical aperture adapted for receipt of the rod; and
wherein the metal foot comprises a fourth vertical aperture adapted for receipt of the rod.

20. The island table of claim 15, wherein each of the plurality of combination wood and metal island legs further comprises:
a projection disposed upon at least one first end of the at least one first leg element, the projection adapted for coupling with the at least one second leg element; and
a recess disposed upon at least one second end of the at least one second leg element and adapted for receipt of the projection and for coupling with the at least one first leg element.
